(19) United States
(12) Patent Application Publication
(10) Pub. No.: US 2026/0179219 A1
(43) Pub. Date: Jun. 25, 2026

(54) METHOD AND SYSTEM FOR TRAINING MACHINE LEARNING MODELS TO PREDICT ABDOMINAL AORTIC ANEURYSM (AAA) GROWTH IN IMAGES

(71) Applicant: VITAA MEDICAL SOLUTIONS INC., Montreal (CA)

(72) Inventors: Atefeh Abdolmanafi, Keswick (CA); Elena Di Martino, Calgary (CA); Arianna Forneris, Edmonton (CA)

(73) Assignee: VITAA MEDICAL SOLUTIONS INC., Montreal, QC (CA)

(21) Appl. No.: 19/125,788

(22) PCT Filed: Oct. 31, 2023
(86) PCT No.: PCT/IB2023/060970

§ 371 Date: Apr. 30, 2025

Related U.S. Application Data
(60) Provisional application No. 63/381,631, filed on Oct. 31, 2022.

(51) Int. Cl. G06T 7/00; G06T 7/11; G06V 10/50; G06V 10/82

(52) U.S. Cl. CPC G06T 7/0012; G06T 7/11; G06V 10/50; G06V 10/82

(57) ABSTRACT

There is provided a method and a system for training and using one or more machine learning (ML) models to predict abdominal aortic aneurysm (AAA) growth based on at least one image of a given patient having been previously diagnosed with AAA. Baseline and follow-up images of patients having AAA are received and compared to determine difference in aortic areas, and each baseline image is labelled as showing significant AAA growth or non-significant AAA growth based on the determined differences. Features are extracted from the aortic areas of the baseline images and include one or more of shape features, texture features or deep features. ML models are trained to classify baseline images as showing significant AAA growth or not based on the extracted features. Calcification accumulation in the baseline images is also determined as an indicator of AAA growth.

### FIELD

The present technology pertains to the field of medical imaging. More precisely, the present technology relates to methods and systems for training machine learning (ML) models and using the ML models to predict abdominal aortic aneurysm (AAA) growth in images.

### BACKGROUND

An abdominal aortic aneurysm (AAA) is defined as a focal dilation of the aorta, which results in progression and rupture if it is not diagnosed and treated. Although aneurysms with diameter exceeding 5-5.4 cm are considered at a risk of rupture, the annual estimation of 5% unexpected rupture risk for aneurysms with a diameter of less than 5 cm indicates a contribution of other factors in AAA growth. Indeed, diameter is not only insufficient, but also inaccurate if used as the only determinant factor of evaluating AAA growth. The reason is that the growth rate is a patient-specific factor, which varies in each individual over time.

Arterial wall remodeling, abnormal blood pattern and recirculation in the AAA sac, as well as intraluminal thrombus (ILT) formation are other important factors to be considered in investigating AAA evolution.

### SUMMARY

It is an object of the present technology to ameliorate at least some of the inconveniences present in the prior art. One or more implementations of the present technology may provide and/or broaden the scope of approaches to and/or methods of achieving the aims and objects of the present technology.

Developers of the present technology have appreciated that machine learning techniques could be used to identify image-based parameters that correlate with aneurysm growth in images.

Developers of the present technology propose investigating the role of lumen information including lumen shape and lumen contrast in images as indicators of AAA growth.

Developers have recognized that lumen shape and lumen contrast are central to hemodynamics and the development of flow patterns. With reference to FIG. 1A, there is shown a first CT image 20 of a body of a patient having been diagnosed with AAA and showing considerable AAA growth, where it can be seen that the lumen 22 has a deviation from a circular shape.

Developers have also recognized that lumen contrast inhomogeneity carries information regarding the blood flow patterns and is indicative of regions of slow and/or disturbed flow that relate to inflammatory mechanisms in the wall. With reference to FIG. 1B, there is shown a second CT image 30 of a body of a patient having been diagnosed with AAA and showing considerable AAA growth where it can be seen that contrast inhomogeneity in the lumen 32 represents disturbed blood flow.

Further, the presence of calcifications in the ILT and wall of the aneurysm may be linked to further damage of the wall.

Developers of the present technology propose investigating the contribution of features extracted from lumen, ILT, and calcifications to AAA growth prediction by using machine learning models.

One or more implementations of the present technology enable improving growth prediction by introducing image information related to lumen, ILT, and calcification. One or more implementations of the present technology propose using features extracted from the images as a tool to investigate flow disturbances in the aorta.

Thus, one or more implementations of the present technology are directed to a method of and a system for training and using machine learning models to predict abdominal aortic aneurysm (AAA) growth in images based on features thereof.

In one or more alternative implementations of the present technology, the methods, systems and non-transitory storage medium may be adapted and used to predict growth of other types of aneurysms in blood vessels, such as thoracic aneurysms.

In accordance with a broad aspect of the present technology, there is provided a method for training at least one classifier to predict growth of an aneurysm in images acquired by a medical imaging apparatus, the method being executed by at least one processor. The method comprises: for each patient of a plurality of patients: receiving a set of baseline images and a set of follow-up images having been acquired by the medical imaging apparatus in a different imaging session, each patient having been diagnosed with the aneurysm, comparing the set of baseline images and the set of follow-up image to determine a respective difference in vessel areas for each respective subset of the baseline images and associated subset of follow-up images. In response to the respective difference in aortic areas being above a threshold: labelling the respective subset of baseline images with a respective significant aneurysm growth label. In response to the respective difference in aortic areas being below a threshold for the respective subset of baseline image and the associated subset of follow-up images: labelling the respective subset of baseline images with a respective non-significant aneurysm growth label; extracting, for the respective subset of baseline images, a respective set of features from the aortic area, training at least one classifier to classify the set of baseline images based on the respective set of features by using the respective label as a target, said training comprising, for each baseline image, classifying, using the at least one classifier, based on the set of features, the respective subset of baseline images as showing one of significant and non-significant aneurysm growth to obtain a respective prediction of aneurysm growth, and updating at least one parameter of the at least one classifier based on the respective prediction and the respective label, and outputting a trained classifier comprising updated parameters.

In accordance with a broad aspect of the present technology, there is provided a method for training at least one classifier to predict abdominal aortic aneurysm (AAA) growth in images acquired by a medical imaging apparatus, the method being executed by at least one processor. The method comprises: for each patient of a plurality of patients: receiving a set of baseline images and a set of follow-up images having been acquired by the medical imaging apparatus in a different imaging session, each patient having been diagnosed with AAA, comparing the set of baseline images and the set of follow-up image to determine a respective difference in aortic areas for each respective subset of the baseline images and associated subset of follow-up images, in response to the respective difference in aortic areas being above a threshold: labelling the respective subset of baseline images with a respective significant AAA growth label, and in response to the respective difference in aortic areas being below a threshold for the respective subset of baseline image and the associated subset of follow-up images: labelling the respective subset of baseline images with a respective non-significant AAA growth label, extracting, for the respective subset of baseline images, a respective set of features from the aortic area, training at least one classifier to classify the set of baseline images based on the respective set of features by using the respective label as a target, said training comprises, for each baseline image, classifying, using the at least one classifier, based on the set of features, the respective subset of baseline images as showing one of significant and non-significant AAA growth to obtain a respective prediction of AAA growth, and updating at least one parameter of the at least one classifier based on the respective prediction and the respective label, and outputting a trained classifier comprises updated parameters.

In one or more implementations of the method, the respective set of features comprises shape features having been extracted from a lumen in the baseline image.

In one or more implementations of the method, the shape features comprise histogram of oriented gradients (HOG) features.

In one or more implementations of the method, the respective set of features comprises texture features indicative of contrast having been extracted from a lumen in the baseline image.

In one or more implementations of the method, the texture features comprise gray-level co-occurrence matrix (GLCM) features.

In one or more implementations of the method, said extracting, for the respective baseline image, the respective set of features comprises using at least one feature extractor to extract deep features from the lumen in images acquired by the medical imaging apparatus.

In one or more implementations of the method, the at least one feature extractor is configured to extract deep features from a lumen, vessel walls and an intraluminal thrombus (ILT).

In one or more implementations of the method, the at least feature extractor comprises a convolutional neural network (CNN).

In one or more implementations of the method, the at least one classifier comprises ensemble trees.

In one or more implementations of the method, each respective subset of baseline images comprises a plurality of baseline images and each associated subset of follow-up images each comprises an associated plurality of follow-up images.

In one or more implementations of the method, the respective difference in aortic areas comprises a respective difference in aortic areas parallel to the transverse plane and parallel to the sagittal plane.

In accordance with a broad aspect of the present technology, there is provided a method for predicting predict growth of an aneurysm based on at least one image of a given patient having been previously diagnosed with the aneurysm, the method being executed by at least one processor, the processor having access to a trained classifier having been trained to classify images of patients as being indicative of aneurysm growth or as not being indicative of aneurysm growth. The method comprises: receiving a set of images of a body comprising an aorta of the given patient, the set of images comprising at least one image, the set of images having been acquired using a medical imaging apparatus, segmenting, using at least one trained segmentation model, each of the set of images to extract a vessel area comprising a lumen of the given patient, extracting, from the lumen, a set of features comprising lumen shape features indicative of a shape of the lumen, classifying, using the trained classifier, based on at least the set of features, each subset of the set of images as being indicative of aneurysm growth or not being indicative of aneurysm growth to obtain a set of classified images for the given patient, and predicting if the patient will show aneurysm growth based on at least the classified set of images, and outputting the prediction.

In accordance with a broad aspect of the present technology, there is provided a method for predicting abdominal aortic aneurysm (AAA) growth based on at least one image of a given patient having been previously diagnosed with AAA, the method being executed by at least one processor, the processor having access to a trained classifier having been trained to classify images of patients as being indicative of AAA growth or as not being indicative of AAA growth. The method comprises: receiving a set of images of a body comprises an aorta of the given patient, the set of images comprises at least one image, the set of images having been acquired using a medical imaging apparatus, segmenting, using at least one trained segmentation model, each of the set of images to extract an aortic area comprises a lumen of the given patient, extracting, from the lumen, a set of features comprises lumen shape features indicative of a shape of the lumen, classifying, using the trained classifier, based on at least the set of features, each subset of the set of images as being indicative of AAA growth or not being indicative of AAA growth to obtain a set of classified images for the given patient, and predicting if the patient will show AAA growth based on at least the classified set of images, and outputting the prediction.

In one or more implementations of the method, the method further comprises: segmenting, using the at least one trained segmentation model, calcifications in the aortic area of each of the set of images, calculating an amount of calcification in each of the set of classified images, and determining if the amount of calcification is above a threshold, and in response to the amount of calcification being above the threshold: outputting the amount of calcification as a further indicator of AAA growth for the given patient.

In one or more implementations of the method, the set of features comprises a set of lumen texture features indicative of a contrast of the lumen of the given patient, said classifying is further based on the set of lumen texture features.

In one or more implementations of the method, the set of lumen shape features comprise histogram of oriented gradients (HOG) features.

In one or more implementations of the method, the set of lumen texture features comprise gray-level co-occurrence matrix (GLCM) features.

In one or more implementations of the method, said extracting, from the lumen, the set of features is performed by a feature extraction machine learning (ML) model, the set of features corresponding to deep features.

In one or more implementations of the method, the trained classifier comprises ensemble trees.

In accordance with a broad aspect of the present technology, there is provided a system for training at least one classifier to predict growth of an aneurysm in images acquired by a medical imaging apparatus, the system comprising: a non-transitory computer-readable medium storing instructions, and at least one processor operatively connected to the non-transitory computer-readable medium. The at least one processor, upon executing the instructions, is configured for: for each patient of a plurality of patients: receiving a set of baseline images and a set of follow-up images having been acquired by the medical imaging apparatus in a different imaging session, each patient having been diagnosed with the aneurysm, comparing the set of baseline images and the set of follow-up image to determine a respective difference in vessel areas for each respective subset of the baseline images and associated subset of follow-up images, in response to the respective difference in vessel areas being above a threshold: labelling the respective subset of baseline images with a respective significant aneurysm growth label, and in response to the respective difference in vessel areas being below a threshold for the respective subset of baseline image and the associated subset of follow-up images: labelling the respective subset of baseline images with a respective non-significant aneurysm growth label, extracting, for the respective subset of baseline images, a respective set of features from the vessel area, training at least one classifier to classify the set of baseline images based on the respective set of features by using the respective label as a target, said training comprising, for each baseline image, classifying, using the at least one classifier, based on the set of features, the respective subset of baseline images as showing one of significant and non-significant aneurysm growth to obtain a respective prediction of and updating at least one parameter of the at least one classifier based on the respective prediction and the respective label, and outputting a trained classifier comprising updated parameters.

In accordance with a broad aspect of the present technology, there is provided a system for training at least one classifier to predict abdominal aortic aneurysm (AAA) growth in images acquired by a medical imaging apparatus. The system comprises: a non-transitory computer-readable medium storing instructions, and at least one processor operatively connected to the non-transitory computer-readable medium, the at least one processor, upon executing the instructions, being configured for: for each patient of a plurality of patients: receiving a set of baseline images and a set of follow-up images having been acquired by the medical imaging apparatus in a different imaging session, each patient having been diagnosed with AAA, comparing the set of baseline images and the set of follow-up image to determine a respective difference in aortic areas for each respective subset of the baseline images and associated subset of follow-up images, in response to the respective difference in aortic areas being above a threshold: labelling the respective subset of baseline images with a respective significant AAA growth label, and in response to the respective difference in aortic areas being below a threshold for the respective subset of baseline image and the associated subset of follow-up images: labelling the respective subset of baseline images with a respective non-significant AAA growth label, extracting, for the respective subset of baseline images, a respective set of features from the aortic area, training at least one classifier to classify the set of baseline images based on the respective set of features by using the respective label as a target, said training comprises, for each baseline image, classifying, using the at least one classifier, based on the set of features, the respective subset of baseline images as showing one of significant and non-significant AAA growth to obtain a respective prediction of AAA growth, and updating at least one parameter of the at least one classifier based on the respective prediction and the respective label, and outputting a trained classifier comprises updated parameters.

In one or more implementations of the system, the respective set of features comprises shape features having been extracted from a lumen in the baseline image.

In one or more implementations of the system, the shape features comprise histogram of oriented gradients (HOG) features.

In one or more implementations of the system, the respective set of features comprises texture features indicative of contrast having been extracted from a lumen in the baseline image.

In one or more implementations of the system, the texture features comprise gray-level co-occurrence matrix (GLCM) features.

In one or more implementations of the system, said extracting, for the respective baseline image, the respective set of features comprises using at least one feature extractor to extract deep features from the lumen in images acquired by the medical imaging apparatus.

In one or more implementations of the system, the at least one feature extractor is configured to extract deep features from a lumen, vessel walls and an intraluminal thrombus (ILT).

In one or more implementations of the system, the at least feature extractor comprises a convolutional neural network (CNN).

In one or more implementations of the system, the at least one classifier comprises ensemble trees.

In one or more implementations of the system, each respective subset of baseline images comprises a plurality of baseline images and each associated subset of follow-up images each comprises an associated plurality of follow-up images.

In one or more implementations of the system, the respective difference in aortic areas comprises a respective difference in aortic areas parallel to the transverse plane and parallel to the sagittal plane.

In accordance with a broad aspect of the present technology, there is provided a system for predicting growth of an aneurysm based on at least one image of a given patient having been previously diagnosed with the aneurysm, the system comprising: a non-transitory computer-readable medium storing instructions, and at least one processor operatively connected to the non-transitory computer-readable medium, the at least one processor having access to a trained classifier having been trained to classify images of patients as being indicative of aneurysm growth or as not being indicative of aneurysm growth. The at least one processor, upon executing the instructions, is configured for: receiving a set of images of a body comprising an aorta of the given patient, the set of images comprising at least one image, the set of images having been acquired using a medical imaging apparatus, segmenting, using at least one trained segmentation model, each of the set of images to extract a vessel area comprising a lumen of the given patient, extracting, from the lumen, a set of features comprising lumen shape features indicative of a shape of the lumen, classifying, using the trained classifier, based on at least the set of features, each subset of the set of images as being indicative of aneurysm growth or not being indicative of aneurysm growth to obtain a set of classified images for the given patient, and predicting if the patient will show aneurysm growth based on at least the classified set of images, and outputting the prediction.

In accordance with a broad aspect of the present technology, there is provided a system for predicting abdominal aortic aneurysm (AAA) growth based on at least one image of a given patient having been previously diagnosed with AAA. The system comprises a non-transitory computer-readable medium storing instructions, and at least one processor operatively connected to the non-transitory computer-readable medium, the at least one processor having access to a trained classifier having been trained to classify images of patients as being indicative of AAA growth or as not being indicative of AAA growth. The at least one processor, upon executing the instructions, is configured for: receiving a set of images of a body comprises an aorta of the given patient, the set of images comprises at least one image, the set of images having been acquired using a medical imaging apparatus, segmenting, using at least one trained segmentation model, each of the set of images to extract an aortic area comprises a lumen of the given patient, extracting, from the lumen, a set of features comprises lumen shape features indicative of a shape of the lumen, classifying, using the trained classifier, based on at least the set of features, each subset of the set of images as being indicative of AAA growth or not being indicative of AAA growth to obtain a set of classified images for the given patient, and predicting if the patient will show AAA growth based on at least the classified set of images, and outputting the prediction.

In one or more implementations of the system, the at least one processor is further configured for: segmenting, using the at least one trained segmentation model, calcifications in the aortic area of each of the set of images, calculating an amount of calcification in each of the set of classified images, and determining if the amount of calcification is above a threshold, and in response to the amount of calcification being above the threshold: outputting the amount of calcification as a further indicator of AAA growth for the given patient.

In one or more implementations of the system, the set of features comprises a set of lumen texture features indicative of a contrast of the lumen of the given patient, said classifying is further based on the set of lumen texture features.

In one or more implementations of the system, the set of lumen shape features comprise histogram of oriented gradients (HOG) features.

In one or more implementations of the system, the set of lumen texture features comprise gray-level co-occurrence matrix (GLCM) features.

In one or more implementations of the system, said extracting, from the lumen, the set of features is performed by a feature extraction machine learning (ML) model, the set of features corresponding to deep features.

In one or more implementations of the system, the trained classifier comprises ensemble trees.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression “a server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “computing device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “a computing device” does not preclude multiple computing devices being used in receiving/sending, carrying out or causing to be carried out any task or request, or the consequences of any task or request, or steps of any method described herein. In the context of the present specification, a “client device” refers to any of a range of end-user client computing devices, associated with a user, such as personal computers, tablets, smartphones, and the like.

In the context of the present specification, unless expressly provided otherwise, a computer system may refer, but is not limited to, an “electronic device”, a “computing device”, an “operation system”, a “system”, a “computer-based system”, a “computer system”, a “network system”, a “network device”, a “controller unit”, a “monitoring device”, a “control device”, a “server”, and/or any combination thereof appropriate to the relevant task at hand.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e., its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the servers, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIGS. 1A and 1B illustrate respectively a first CT image with lumen shape deviation in a patient with considerable AAA growth and a second CT image with lumen contrast inhomogeneity in a patient with considerable AAA growth.

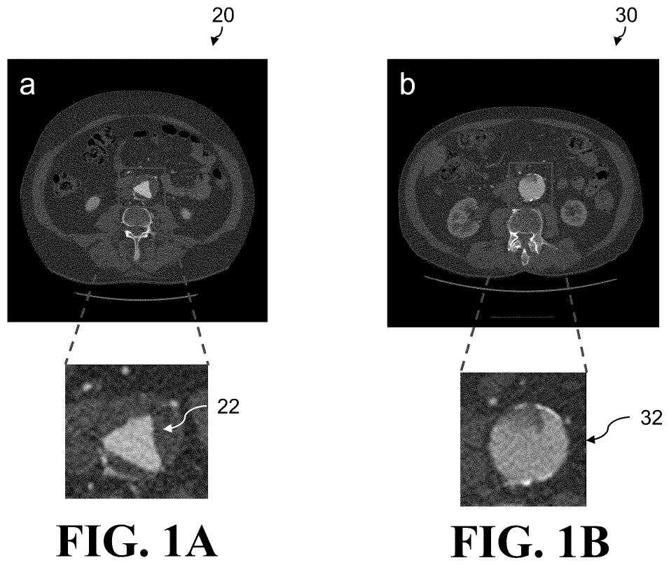

FIG. 2 illustrates a schematic diagram of an electronic device in accordance with one or more non-limiting implementations of the present technology.

FIG. 3 illustrates a schematic diagram of a communication system in accordance with one or more non-limiting implementations of the present technology.

FIG. 4 illustrates a schematic diagram of an AAA growth prediction training procedure in accordance with one or more non-limiting implementations of the present technology.

FIG. 5 illustrates inputs and outputs of a feature extraction procedure in accordance with one or more non-limiting implementations of the present technology.

FIG. 6 illustrates inputs and outputs of a registration procedure and a comparison procedure in accordance with one or more non-limiting implementations of the present technology.

FIG. 7 illustrates a training procedure in accordance with one or more non-limiting implementations of the present technology.

FIG. 8 illustrates a chart showing calcification accumulations in function of the patient number which compares calcification in slices that were labeled as significant growth versus the slices that were labeled as non-significant growth for each patient in accordance with one or more non-limiting implementations of the present technology.

FIG. 9 illustrates a plot of test classification error as a function of the number of trees obtained during a training procedure in accordance with one or more non-limiting implementations of the present technology.

FIG. 10 illustrates a flowchart of a method for training at least one machine learning (ML) model to predict abdominal aortic aneurysm (AAA) growth, the method being executed in accordance with one or more non-limiting implementations of the present technology.

FIG. 11 illustrates a flowchart of a method for using a machine learning (ML) model to predict abdominal aortic aneurysm (AAA) growth in patients having been diagnosed with AAA, the method being executed in accordance with one or more non-limiting implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting implementations of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

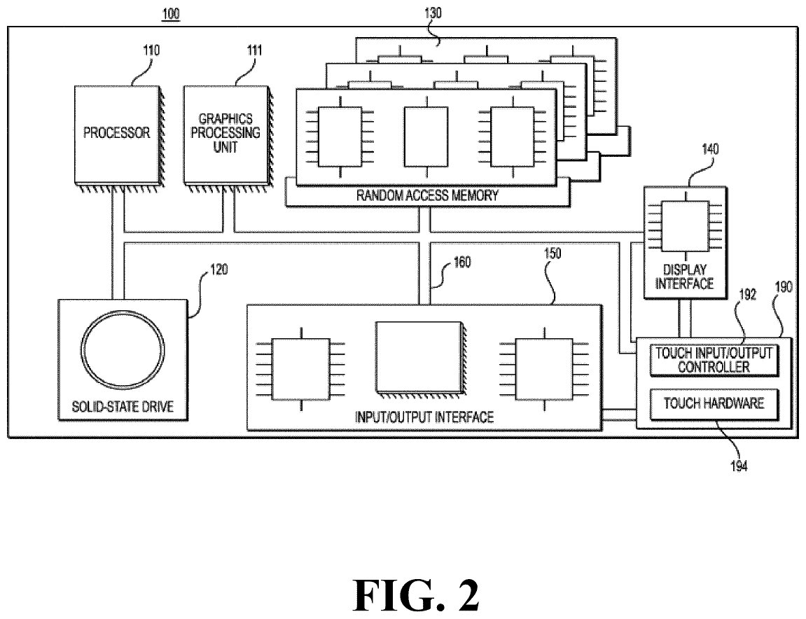

With reference to FIG. 2, there is illustrated a schematic diagram of an computing device 100 suitable for use with some non-limiting implementations of the present technology.

### Electronic Device

The computing device 100 comprises various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computing device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some implementations, the touchscreen 190 is the display. The touchscreen 190 may equally be referred to as a screen 190. In the implementations illustrated in FIG. 2, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some implementations, the input/output interface 150 may be connected to a keyboard (not shown), a mouse (not shown) or a trackpad (not shown) allowing the user to interact with the computing device 100 in addition or in replacement of the touchscreen 190.

According to implementations of the present technology, the solid-state drive 120 stores program instructions suitable for being loaded into the random-access memory 130 and executed by the processor 110 and/or the GPU 111 for training machine learning models to predict abdominal aortic aneurysm (AAA) growth in images based on features thereof. For example, the program instructions may be part of a library or an application.

The computing device 100 may be implemented in the form of a server, a desktop computer, a laptop computer, a tablet, a smartphone, a personal digital assistant or any device that may be configured to implement the present technology, as it may be understood by a person skilled in the art.

### System

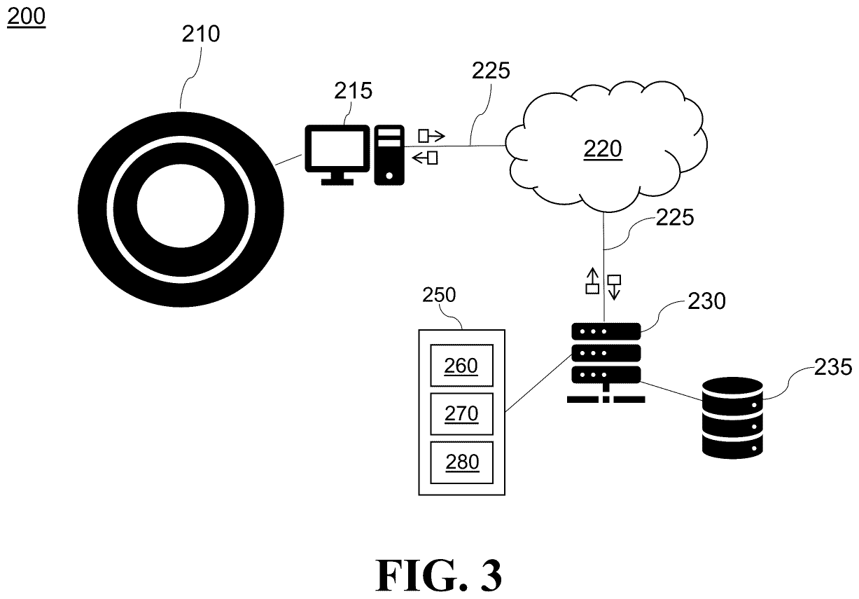

Referring to FIG. 3, there is shown a schematic diagram of a communication system 200, which will be referred to as the system 200, the system 200 being suitable for implementing non-limiting implementations of the present technology. It is to be expressly understood that the system 200 as illustrated is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a medical imaging apparatus 210, a workstation computer 215, a server 230 and a database 235 coupled over a communications network 220 via respective communication links 225 (not separately numbered).

In one or more implementations, at least a portion of the system 200 implements the Picture Archiving and Communication System (PACS) technology.

The medical imaging apparatus 210 is operated by a user (e.g., physician or technician) to acquire medical images of the body of a given patient. The acquisition parameters may be controlled via workstation computer 215.

### Medical Imaging Apparatus

The medical imaging apparatus 210 is configured to inter alia: (i) acquire, according to acquisition parameters, images of a body of a given subject; and (ii) transmit the images to the workstation computer 215.

The medical imaging apparatus 210 may comprise one of: a computed tomography (CT) scanner, a magnetic resonance imaging (MRI) scanner, a 3D ultrasound and the like.

In some implementations of the present technology, the medical imaging apparatus 210 may comprise a plurality of medical imaging apparatuses, such as one or more of a computational tomography (CT) scanner, a magnetic resonance imaging (MRI) scanner, a 3D ultrasound, and the like.

The medical imaging apparatus 210 may be configured with specific acquisition parameters for acquiring images of the patient. In the context of the present technology, the images of the body of the patient comprise aorta(s) and/or iliac arteries. The images of the body of the patient may include a thoracic area (e.g., ascending aorta, aortic arch, descending thoracic aorta) and/or abdominal aorta area (e.g., suprarenal abdominal aorta, infrarenal aorta, renal arteries, lumbar arteries) and iliac arteries (e.g., common iliac arteries, external iliac arteries, internal iliac arteries).

In one or more implementations, the medical imaging apparatus 210 is configured to acquire a set of images comprising at least one image. In one or more implementations, the set of images may be static images. In one or more other implementations, the set of images may be dynamic images in the form of a multiphase stack.

It will be appreciated that in at least some cases, patients are provided with contrast agents, also known as contrast mediums, to increase the contrast of structures or fluids within their body when acquisition of images is performed using the medical imaging apparatus 210.

As a non-limiting example, in one or more implementations where the medical imaging apparatus 210 is implemented as a CT scanner, a CT protocol comprising pre-operative retrospectively gated multidetector CT (MDCT—64-row multi-slice CT scanner) with variable dose radiation to capture the R-R interval may be used.

As another non-limiting example, in one or more implementations where the medical imaging procedure comprises a MRI scanner, the MR protocol can comprise steady state T2 weighted fast field echo (TE=2.6 ms, TR=5.2 ms, flip angle 110-degree, fat suppression (SPIR), echo time 50 ms, maximum 25 heart phases, matrix 256×256, acquisition voxel MPS (measurement, phase and slice encoding directions) 1.56/1.56/3.00 mm and reconstruction voxel MPS 0.78.

In one or more alternative implementations, the medical imaging apparatus 210 may include or may be connected to a workstation computer (not illustrated) for inter alia control of acquisition parameters and image data transmission.

In one or more implementations, the workstation computer 215 may be provided together with the medical imaging apparatus 210, e.g., in a housing thereof. In one or more other implementations, the workstation computer 215 may be implemented as a mobile device such as a smartphone or a tablet.

In one or more implementations, the medical imaging apparatus 210 is part of a Picture Archiving and Communication System (PACS) for storing and retrieving medical images together other electronic devices such as the server 230.

### Server

The server 230 is configured to inter alia train a set of machine learning (ML) models 250 to perform predictions of AAA growth in images.

How the server 230 is configured to do so will be explained in more detail herein below.

The server 230 can be implemented as a conventional computer server and may comprise some or all of the components of the computing device 100 illustrated in FIG. 2. In an example of one or more implementations of the present technology, the server 230 can be implemented as a Dell™ PowerEdge™ Server running the Microsoft™ Windows Server™ operating system. Needless to say, the server 230 can be implemented in any other suitable hardware and/or software and/or firmware or a combination thereof. In the illustrated non-limiting implementation of present technology, the server 230 is a single server. In alternative non-limiting implementations of the present technology, the functionality of the server 230 may be distributed and may be implemented via multiple servers (not illustrated).

The implementation of the server 230 is well known to the person skilled in the art of the present technology. However, briefly speaking, the server 230 comprises a communication interface (not illustrated) structured and configured to communicate with various entities (such as the workstation computer 215, for example and other devices potentially coupled to the network 220) via the communications network 220. The server 230 further comprises at least one computer processor (e.g., a processor 110 or GPU 111 of the computing device 100) operationally connected with the communication interface and structured and configured to execute various processes to be described herein.

In one or more implementations, the server 230 may be implemented as the computing device 100 or comprise components thereof, such as the processor 110, the graphics processing unit (GPU) 111, the solid-state drive 120, the random-access memory 130, the display interface 140, and the input/output interface 150.

It will be appreciated that the server 230 may provide the output of one or more processing steps to another electronic device for display, confirmation and/or troubleshooting. As a non-limiting example, the server 230 may transmit images, calculated values, results, machine learning parameters, for display on a client device configured similar to the computing device 100 such as a smart phone, tablet, and the like.

The server 230 has access to the set of machine learning (ML) models 250.

### Machine Learning (ML)

The set of ML models 250 comprises inter alia a set of feature extraction models 260, a set of classification ML models 270, and a set of segmentation ML models 280.

It should be understood that in the context of the present technology, machine learning methods include deep learning methods.

ML models are referred to as models hereinafter.

Each of the set of models 250 is parametrized by inter alia model parameters and hyperparameters.

The model parameters are configuration variables of the model which are used to perform predictions and are estimated or learned from training data, i.e. the coefficients are chosen during learning based on an optimization strategy for outputting a prediction. The hyperparameters are configuration variables of a model which determine the structure of the initial model and how the initial model is trained.

It will be appreciated that the number of model parameters to initialize will depend on inter alia the type of model (e.g., classification or regression), the architecture of the model (e.g., DNN, SVM, Random Forest, Ensemble tree, etc.), and the model hyperparameters (e.g. a number of layers, type of layers, number of neurons in a NN, number of trees, etc.).

In one or more implementations, the hyperparameters include one or more of: a number of hidden layers and units, an optimization algorithm, a learning rate, momentum, an activation function, a minibatch size, a number of epochs, a dropout, and/or the like.

### Feature Extraction Models

The set of feature extraction models 260, also referred to as the set of feature extractors 260, are configured to extract features from images received from the medical imaging apparatus 210.

The set of feature extraction models 260 may include one or more models.

Features extracted by the set of feature extraction models 260, which are referred to as deep features, will be used by prediction models (e.g., classifiers) to perform a respective prediction.

In the context of the present technology, the set of feature extraction models 260 are used to extract deep features that are indicative of AAA growth in images. The deep features may be extracted from segmented tissues, for example output by the segmentation models 280. In one or more alternative implementations, deep features may be extracted from the baseline images directly.

It will be appreciated that the features extracted by the set of feature extraction models 260 may be represented in the form of a feature vector. The number of features in the feature vector is not limited. As a non-limiting example, the set of features may be a feature vector of 1024 or 2048 dimensions.

The set of feature extraction models 260 may comprise one or more different types of feature extraction models for performing extraction of deep features from images. As a non-limiting example, the initial feature extractor may be implemented as a ResNet model. The ResNet model may have been pretrained on the ImageNet data. In such implementations, the model parameters of previously trained portions of a common feature extractor may be obtained during model initialization.

One or more feature extraction models of the set of feature extraction models 260 may based on one of: attention mechanisms, autoencoders, inception networks, DenseNet, Generative Adversarial Networks (GANs), DenseNet, AlexNet, GoogleNet, VGG and the like.

### Classification Models

The set of classification models 270, also referred to as the set of classifiers 270, are configured to inter alia: (i) receive features extracted from images of the aortic area; and (ii) perform, using the extracted features, a respective prediction.

In the context of the present technology, the respective prediction is indicative of AAA growth. In one or more implementations, the respective prediction may be one of: non-significant AAA growth and significant AAA growth.

The set of classification models 270 include a plurality of classification models 270. The set of classification models 270 may be divided into subsets of classification models, were each subset of classification models 270 may be configured to perform predictions based on different types of features, as will be explained below.

As a non-limiting example, the classification models 270 may be implemented based on ensemble trees, support vector machines (SVMs), random forest, neural networks and the like.

In one or more alternative implementations, the set of models 250 may further include a set of regression models (not illustrated). The set of regression models may be configured to receive features extracted from images of the aortic area and perform, based on the extracted features, a respective prediction of AAA growth. As a non-limiting example, the regression models may predict a relative amount of growth or a number indicative of AAA growth.

In the context of the present technology, a model may be formed of plurality of the above-described models, for example reference may be made to a ML model comprising a feature extractor for extracting features of images and a classifier using the extracted features to classify the image.

### Segmentation Models

The set of segmentation models 280 are configured to perform segmentation of tissues in the aortic area. The set of segmentation models 280 includes one or more segmentation ML models.

In one or more implementations, the set of segmentation models 280 are configured to perform semantic segmentation of tissues, i.e., the set of segmentation models 280 are configured to detect all borders (i.e., delimit) and discriminate (i.e., classify) various tissue types in images of the aorta having been acquired by the medical imaging apparatus 210.

The set of segmentation models 280 is configured to segment the outside wall of the aorta, the inside wall of the aorta, the lumen, and the intraluminal thrombus (ILT). Thus, the segmentation model 280 may classify each pixel in medical images as being one of: the outside wall of the aorta, the inside wall of the aorta, the lumen, and the intraluminal thrombus (ILT).

In one or more implementations, the set of segmentation models 280 comprises two segmentation models, each configured to perform a particular segmentation task. As a non-limiting example, the set of segmentation models 280 may include a first segmentation model configured to perform foreground and background segmentation, and a second segmentation model configured to perform multi-class segmentation to detect lumen and calcification (if present). A non-limiting example of such segmentation models is described in International Patent Application No. PCT/IB2022/051558 entitled “METHOD AND SYSTEM FOR SEGMENTING AND CHARACTERIZING AORTIC TISSUES” filed on Feb. 22, 2022 by the same Applicant, the content of which is incorporated herein by reference.

In one or more implementations, the set of segmentation models 280 comprises a fully convolutional neural network (FCN).

The segmentation models 280 have been trained to perform segmentation of the aortic region in images. In one or more implementations, a segmentation model 280 may be trained to perform segmentation based on CT and/or MRI images.

In one or more implementations, the set of segmentation models 280 comprises a ResNet-based FCN architecture. Non-limiting examples of ResNet include ResNet50 (50 layers), ResNet101 (101 layers), ResNet152 (152 layers), ResNet50V2 (50 layers with batch normalization), ResNet101V2 (101 layers with batch normalization), and ResNet152V2 (152 layers with batch normalization).

In one or more alternative implementations, the set of segmentation models 280 may be implemented based on one of: U-Net, V-Net, SegNet, AlexNet, GoogleNet, VGG, DeepLab, Mask R-CNN, GANs, ResNets, Visual Transformers, and the like.

### Database

The database 235 is configured to inter alia: (i) store acquisition parameters and data related to the medical imaging apparatus 210; (ii) store medical images including baseline and follow up image stacks or indications thereof; (iii) store labels associated with and features extracted from the medical images; (iv); store model parameters and hyperparameters of the set of ML models 250 (v) store datasets for training, testing and validating the set of ML models 250; and (vi) store data output by the set of ML models 250.

The database 235 is configured to store medical image stacks and videos. In one or more implementations, the database may store Digital Imaging and Communications in Medicine (DICOM) files, including for example the DCM and DCM30 (DICOM 3.0) file extensions. Additionally or alternatively, the database 235 may store medical image files in the Tag Image File Format (TIFF), Digital Storage and Retrieval (DSR) TIFF-based format, and the Data Exchange File Format (DEFF) TIFF-based format.

In one or more implementations, the database 235 may store ML file formats, such as .tfrecords, .csv, .npy, and .petastorm as well as the file formats used to store models, such as .pb and .pkl. The database 235 may also store well-known file formats such as, but not limited to image file formats (e.g., .png, .jpeg, .exif, .bmp, .tiff), video file formats (e.g., .mp4, .mkv, etc), archive file formats (e.g., .zip, .gz, .tar, .bzip2), document file formats (e.g., .docx, .pdf, .txt) or web file formats (e.g., .html).

### Communication Network

In some implementations of the present technology, the communications network 220 is the Internet. In alternative non-limiting implementations, the communication network 220 can be implemented as any suitable local area network (LAN), wide area network (WAN), a private communication network or the like. It should be expressly understood that implementations for the communication network 220 are for illustration purposes only. How a communication link 225 (not separately numbered) between the workstation computer 215 and/or the server 230 and/or another electronic device (not illustrated) and the communications network 220 is implemented will depend inter alia on how each of the medical imaging apparatus 210, the workstation computer 215, and the server 230 is implemented.

The communication network 220 may be used in order to transmit data packets amongst the workstation computer 215, the server 230 and the database 235. For example, the communication network 220 may be used to transmit requests between the workstation computer 215 and the server 230.

### Growth Prediction Training Procedure

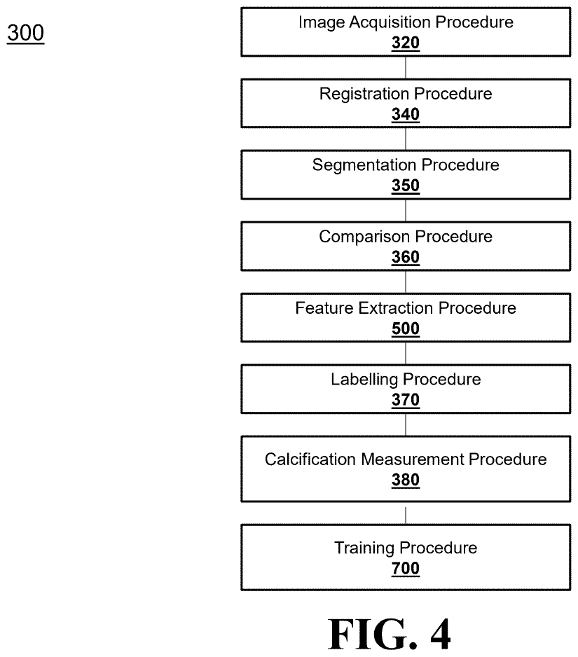

With reference to FIG. 4, there is illustrated a schematic diagram of a training dataset generation procedure 300 in accordance with one or more non-limiting implementations of the present technology.

The training dataset generation procedure 300 is used to generate a training dataset and train one or more ML models 250 in order to predict AAA growth in images acquired by a medical imaging apparatus such as the medical imaging apparatus 210. I

In one or more alternative implementations of the present technology, the training dataset generation procedure 300 may be adapted and used to predict growth of other types of aneurysms in blood vessels, such as thoracic aneurysms.

The purpose of the training dataset generation procedure 300 is to compare baseline images received during a baseline imaging session and images received during a follow-up imaging session to determine if a patient shows significant or non-significant AAA growth. The baseline images are then labelled accordingly, and different types of features (i.e., shape features, texture features and deep features) are extracted from the baseline images, which may be segmented using the set of segmentation models 280. The contribution of the different types of features is then assessed by training the set of classification models 270 to predict AAA growth in images by using the determined labels as ground truth.

The training dataset generation procedure 300 comprises inter alia an image acquisition procedure 320, a registration procedure 340, a segmentation procedure 350, a comparison procedure 360, a feature extraction procedure 500, a labelling procedure 370, a calcification measurement procedure 380, and a training and validation procedure 700.

### Image Acquisition Procedure

The image acquisition procedure 320 is configured to receive, for each patient of a plurality of patients, a set of baseline images and a set of follow-up images, having been acquired by the medical imaging apparatus 210.

The set of baseline images comprises at least one baseline image having been acquired during a first session of imaging of a given patient, and the set of follow-up images comprises at least one follow-up image having been acquired during a subsequent session of imaging with the same given patient. In the context of the present technology, each patient has been diagnosed with an abdominal aortic aneurysm (AAA), and the purpose of the baseline and follow-up imaging sessions is to assess growth of the AAA. It will be appreciated that in some implementations, more than one follow-up session may be considered. In at least some instances, each patient is provided with contrast agents prior to the baseline and follow-up imaging session to enhance contrast of the set of baseline and follow-up images.

It will be appreciated that the set of baseline images and the set of follow-up images may be received at different times and/or from a different device (e.g., medical imaging apparatus 210 and/or workstation computer 215) by the image acquisition procedure 320.

The set of baseline images and the set of follow-up images may each be in the form of a respective image stack each comprising a plurality of images (e.g., dozens or hundreds of images).

It will be appreciated that an image stack comprises a set of sequential images, also referred to as slices, that can be scrolled and are expected for cross-sectional studies (e.g., CT/MRI) as well as for time-resolved modalities. As a non-limiting example, an image stack may be provided in the DICOM file format.

In one or more implementations, the image stack may be in the form of a multiphase stack, where each phase of the multiphase stack may correspond to a time instance. As a non-limiting example, each phase in the stack may correspond to a moment in the cardiac cycle of the given patient.

In one or more alternative implementations, where the set of baseline images includes only one baseline image and where the set of follow-up images includes only one follow-up image for each patient, the total number of images (or patients) may need to be sufficient to ensure optimal training and prevent overfitting of machine learning models.

In one or more alternative implementations, the baseline images and the follow-up images may have been acquired by different types of medical imaging apparatus (e.g., CT and MRI) and may be registered in the same frame of reference during the registration procedure 340.

The image acquisition procedure 320 outputs, for each patient of a plurality of patients, a set of baseline images and a set of follow-up images showing at least the aortic area.

It will be appreciated that indications of the set of baseline images and the set of follow-up images of the same patient may be associated together in pairs, i.e., a subset of baseline images may be associated with a corresponding subset of follow-up images.

### Registration Procedure

The registration procedure 330 is configured to perform registration of the set of baseline images and the set of follow-up images to ensure correspondence between the images.

Registration is performed to bring modalities involved into a common frame of reference (i.e., spatial alignment) so that the information they contain can be optimally integrated or compared.

As a non-limiting example, the registration procedure 330 may be performed by using software Simpleware™ ScanIP™ (Synopsys Inc., Mountain View, California) to perform registration of the baseline and follow-up images.

The registration procedure 330 outputs registered baseline and follow-up images. In one or more implementations, the registration procedure 330 outputs a registered baseline stack and a registered follow-up stack.

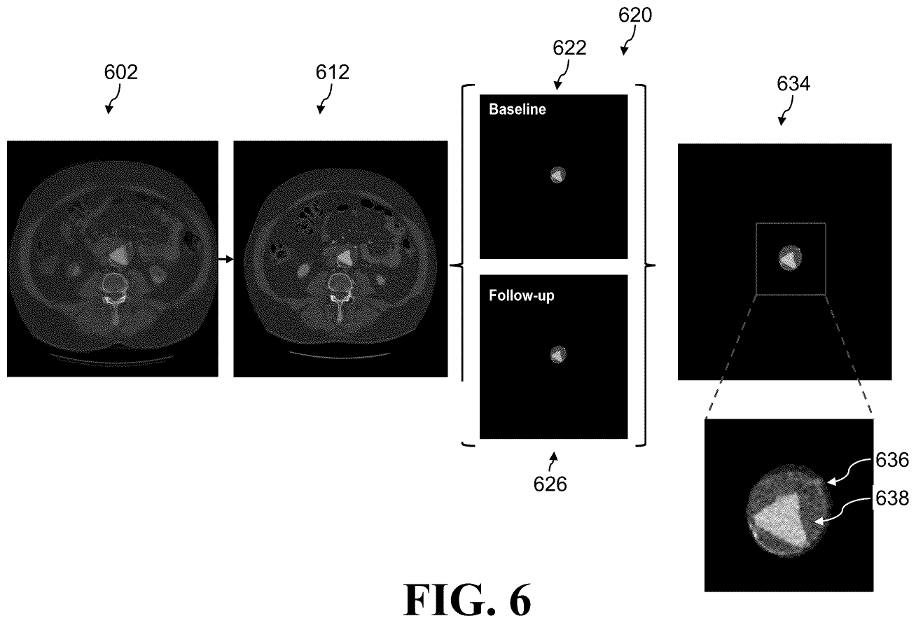

With brief reference to FIG. 6, there is illustrated baseline and follow-up slices pre-registration 602, and the baseline and follow-up slices post-registration 612 output by the registration procedure 330.

Turning back to FIG. 4, the procedure 300 comprises the segmentation procedure 350.

### Segmentation Procedure

The segmentation procedure 350 is configured to inter alia: (i) receive baseline and follow-up images; and (ii) segment aortic tissues in the baseline and follow-up images.

The segmentation procedure 350 uses a set of segmentation models 280 having been trained to segment aortic tissues in images acquired by an imaging apparatus, such as the medical imaging apparatus 210.

The segmentation procedure 350 uses the set of segmentation models 280 to segment tissues in the baseline images and in follow-up images. The baseline images and follow-up images may each be in the form of an image stack comprising a plurality of slices.

The segmentation procedure 350 obtains, for each pair of follow-up image and associated baseline image, a segmented aortic area comprising one or more of an aorta and iliac arteries. In one or more implementations, the segmented aortic area comprises a region of interest (ROI) including the lumen, inside and outside aortic wall, ILT (if present), and calcifications (if present).

In one or more implementations, the segmentation procedure 350 is configured to extract, for each pair of follow-up and baseline images, the segmented tissues to obtain at least one image per segmented tissue. It will be appreciated that the segmented tissues may be extracted by performing masking.

With brief reference to FIG. 6, there is illustrated a pair 620 comprising a baseline extracted ROI 622 and a follow-up extracted ROI 626 output by the segmentation procedure 350.

Turning back to FIG. 4, the segmentation procedure 350 is followed by a comparison procedure 360.

### Comparison Procedure

The comparison procedure 360 is configured to measure a difference between the segmented aortic areas in the set of follow-up image(s) and the set of baseline image(s) for each patient.

In one or more implementations, the comparison procedure 360 measures a difference in the number of pixels between the subset of baseline images and the associated subset of follow-up images. The subset of baseline images is a proper subset of the baseline images and the subset of follow-up images is a proper subset of follow-up images. Thus, a set of images may include a plurality of subsets of images. In one or more implementations, each subset comprises one image. In one or more other implementations, each subset comprises two or more images.

In one or more implementations, the comparison procedure 360 measures the difference between the segmented aortic areas in each slice of a baseline image stack and a corresponding slice in the follow-up image stack.

In one or more alternative implementations, the comparison procedure 360 measures a difference in the number of pixels between the whole subset of baseline images and the whole subset of follow-up images.

In one or more implementations, the comparison procedure 360 measures the number of non-zero pixels for extracted ROIs at baseline N_{B} and the number of non-zero pixels for extracted ROIs at follow-up N_{F}. For each slice of each patient, the difference (D) between the non-zero pixels at baseline and follow-up is determined by using equation (1):

$$D = {N}_{F} - {N}_{B} \qquad ( 1 )$$

The comparison procedure 360 thus determines the difference in number of pixels for each corresponding slice in the baseline and follow-up image stack.

The comparison procedure 360 is configured to compare the difference between the segmented aortic areas in the follow-up image(s) and the baseline image(s) for each patient to at least one given threshold.

If the difference is equal to or above a given threshold, the comparison procedure 360 determines that the patient shows significant AAA growth for a given pair of baseline and follow-up images (i.e., slice). If the difference is below the given threshold, the comparison procedure 360 determines that the patient does not show significant AAA growth for a given pair of baseline and follow-up images (i.e., slice).

In one or more alternative implementations, there may two or more levels of AAA growth (thresholds).

In one or more implementations, the comparison procedure 360 determines a threshold based on the third quartile (Q₃) of the measured difference of pixels (Ds) over all the slices of all the patients. If the difference is below the third quartile, the comparison procedure 360 determines that the patient is showing non-significant AAA growth. If the difference is equal to or above the third quartile, the comparison procedure 360 determines that the patient is showing significant AAA growth. It will be appreciated that the threshold may be determined using other techniques.

The comparison procedure 360 determines if a patient shows significant or non-significant AAA growth based on equations (2) and (3):

$$Non - significant growth : D < {Q}_{3} \qquad ( 2 )$$

$$Significant growth : D \geq {Q}_{3} \qquad ( 3 )$$

The comparison procedure 360 associates each slice of each patient with an indication of whether the patient shows non-significant AAA growth or significant AAA growth. As a non-limiting example, this association may be stored in the database 235 or another storage medium. The comparison procedure 360 may for example associate each baseline image of each patient with an indication of non-significant AAA growth or significant AAA growth.

The indication of non-significant AAA growth or significant AAA growth will be used, by the labelling procedure 370, as a label for labelling extracted features from each baseline image, as will be explained in more detail herein below. The labels will be used as ground truth to train machine learning models during a supervised learning procedure.

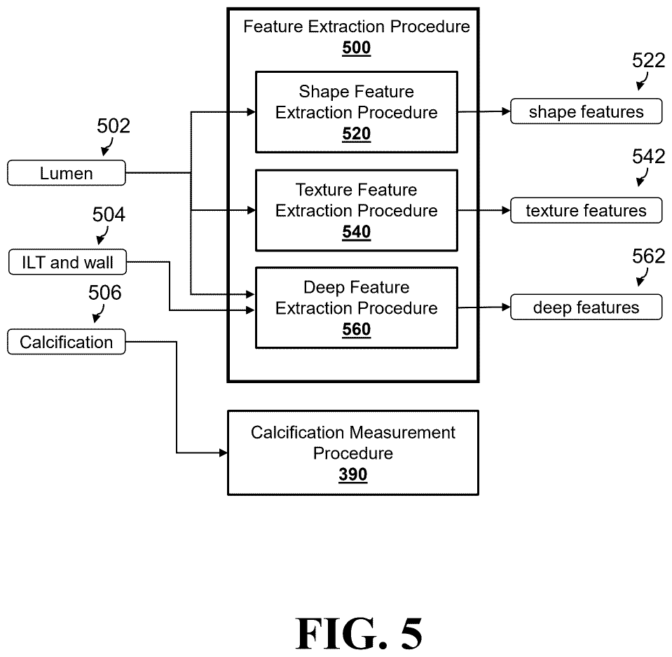

The procedure 300 is configured to perform a feature extraction procedure 500 to extract different types of features from baseline images, which will be explained with reference to FIG. 4 and FIG. 5.

### Feature Extraction Procedure

The feature extraction procedure 500 is used to extract different types of features from each of the baseline images such that prediction models may be trained to predict AAA growth based on the different types of features and their performance may be assessed.

In one or more implementations, the feature extraction procedure 500 is executed by the server 230.

The feature extraction procedure 500 comprises inter alia a shape feature extraction procedure 520, a texture feature extraction procedure 540, and a deep feature extraction procedure 560.

It will be appreciated that the shape feature extraction procedure 520, the texture feature extraction procedure 540, and the deep features extraction procedure 560 may be executed by the same electronic device or by different electronic devices, and they may be executed in parallel or sequentially.

### Shape Feature Extraction Procedure

The shape feature extraction procedure 520 is configured to extract, from the baseline images, shape features 522. The shape features 522 are image features that are indicative of shape of elements (e.g., objects) in the image.

It will be appreciated that shape features may be invariant to scaling, rotation, and translation of the object and is naturally either 2D or 3D depending on the object.

In one or more implementations, the shape feature extraction procedure 520 extracts the shape features from the segmented baseline images.

The shape feature extraction procedure 520 may extract the shape features from at least one of: the aortic wall, the ILT, the lumen, and calcifications, having been segmented in the baseline images by the segmentation procedure 350.

In one or more implementations, the at least one of the aortic walls, the ILT, the lumen and calcifications (when present) have been extracted from each slice of a baseline image stack for each patient.

In one or more implementations, the shape feature extraction procedure 520 is configured to perform histogram of oriented gradients (HOG) to extract the shape features. Such shape features may be referred to as HOG features.

Histogram of oriented gradients is commonly used for shape recognition in the localized portion of an image using the distribution of intensity gradients and edge direction. For this purpose, the image is divided into small cells and histogram of gradient directions is calculated for the pixels within each cell. All the histograms are concatenated to extract the final feature vector which represents the shapes in the image. Gray-scale images of the lumen may be used. In one example experiment, the images were not cropped to ensure that no shape information is lost. Instead, to accelerate the calculations during the example experiment, the images were resized to 400×400 pixels with 8×8 cell size.

The shape feature extraction procedure 520 outputs shape features 522 of the segmented lumen for each baseline image.

In one or more implementations, the shape feature extraction procedure 520 associates, in the database 235 or another storage medium, the shape features 522 with an indication of the patient and/or the baseline image they were extracted from such that they can be retrieved during training.

Thus, for a given patient, each subset of baseline images is associated with shape features 522, where the shape features 522 include shape features extracted from the lumen and/or shape features extracted from the ILT.

It will be appreciated that in one or more alternative implementations, shape features may be extracted for each segmented tissue in the baseline image(s).

### Texture Feature Extraction Procedure

The texture feature extraction procedure 540 is configured to extract, from the baseline images, texture features 542.

In one or more implementations, the texture feature extraction procedure 540 receives the segmented lumen 502 extracted from the baseline images.

The texture feature extraction procedure 540 extracts, from the segmented lumen, texture features 542.

Image texture features quantify the perceived texture of an image and provides information about the spatial arrangement of color or intensities in an image or selected region of an image. It will be appreciated that extraction of image texture features may be performed using one of a structured approach or a statistical approach.

In one or more implementations, the texture feature extraction procedure 540 is configured to perform Texture Analysis Using the Gray-Level Co-Occurrence Matrix (GLCM) to extract the texture features. It will be appreciated that images may be converted to grayscale before extraction of the GLCM features.

Texture-based statistical approaches are used to estimate the gray-level spatial distribution of an image by specifying the local features of each pixel and extracting the statistics from their distribution. GLCM considers the spatial relationships among pixels in different orientations. A co-occurrence matrix is extracted from a gray-level image and demonstrates the frequency of occurring a pixel with value i in the vicinity of pixels with values j through the horizontal, vertical, or diagonal directions specified by a given offset. Contrast, homogeneity, correlation, and energy are the most significant parameters, which can be extracted from GLCM. Contrast is defined as the local gray-level changes in GLCM. Homogeneity measures the uniformity of the non-zero values of GLCM; the lower homogeneity means the higher gray-level variations and consequently the higher contrast. Correlation calculates the joint probability of occurring particular pixel pairs in gray-level and energy is the measure of uniformity of the texture, which shows the local homogeneity. Therefore, when energy is high, the homogeneity is high as well.

In one or more implementations, the texture feature extraction procedure 540 extracts GLCMs from each patch with a size of 3×3 pixels and the pixel of interest is the pixel at the center of the patch.

In one or more implementations, to reduce computation time, all the patches that belong to the image background (and which have not been segmented) are ignored to ensure that all the features are only extracted from the lumen. Multiple GLCMs may be extracted based on the spatial relationship between the pixel of interest and its adjacent pixel in different orientations of 0, 45, 90, and 135 degrees.

In one or more implementations, for each GLCM, the statistical properties are calculated as a vector of contrast, energy and homogeneity values using equations (4)-(6).

$$Contrast : {\sum }_{i , j} {\vert i - j \vert}^{2} \cdot p ( i , j ) \qquad ( 4 )$$

$$Energy : {\sum }_{i , j} {P ( i , j )}^{2} \qquad ( 5 )$$

$$Homogeneity : {\sum }_{i , j} ( \frac{p ( i , j )}{1 + \vert 1 - j \vert} \qquad ( 6 )$$

The texture feature extraction procedure 540 outputs texture features 542 of the segmented lumen for each subset of baseline images.

In one or more implementations, the shape feature extraction procedure 520 associates, in the database 235 or another storage medium, the texture features 542 with an indication of the baseline image they were extracted from such that they can be retrieved during training.

Thus, for a given patient, each baseline image is associated with texture features 542, where the texture features 542 include texture features extracted from the lumen.

It will be appreciated that in one or more alternative implementations, texture features may be extracted for each segmented tissue in the baseline image(s).

### Deep Feature Extraction Procedure

The deep feature extraction procedure 560 is configured to use one or more feature extraction models 260, also referred to as feature extractors 260, to extract deep features 562 from the baseline images.

In one or more implementations, the deep feature 562 are extracted for each subset of the set of baseline images.

In one or more implementations, the deep feature extraction procedure 560 receives the segmented lumen 502 and the segmented ILT and wall 506 extracted from the baseline images by the segmentation models 280.

In one or more implementations, the deep feature extraction procedure 560 uses deep feature extractors 260 to extract the deep features 562.

Convolutional neural networks (CNNs) are recognized as strong feature extractors which can provide all the information in an image starting from the abstract level information such as shape, borders, and edges to detailed texture information. CNNs are categorized as shallow networks, deep networks, and complex networks based on their architectures.

Non-limiting examples of feature extractors 260 include autoencoders, inception networks, DenseNet, GANs, DenseNet, ResNet, VGG, GoogleNet and AlexNet.

In one or more implementations, the feature extractor is implemented as VGG-19 to extract features from the lumen and the ILT, and the features are extracted from the fully connected layer FC8, and each baseline slice is represented by a feature vector of size 1×1000. It will be appreciated that other implementations of the feature extractor may be possible and within the scope of the present technology.

The deep feature extraction procedure 560 extracts deep features from the segmented lumen 502.

The deep feature extraction procedure 560 extracts deep features from the segmented ILT and wall 504.

In one or more implementations, the deep feature extraction procedure 560 associates, in the database 235 or another storage medium, the deep features 562 with an indication of the tissue and baseline image they were extracted from such that they can be retrieved during training.

Thus, for a given patient, each baseline image is associated with deep features 562, where the deep features include deep features generated based on the lumen 502 and/or deep features generated based on the ILT and wall 504.

### Labelling Procedure

In one or more implementations, the labelling procedure 370 is configured to associate each of the types of features (shape features, texture features and deep features extracted from the segmented ROIs) obtained during the feature extraction procedure 500 with an indication of a label based on results from the comparison procedure 360.

The labelling procedure 370 labels each baseline image and/or each patient with a respective label, the respective label being one of: non-significant AAA growth and significant AAA growth. The labelling procedure 370 may then associate the extracted features with the respective label.

As a non-limiting example, the features may be stored in the database 235 (or another storage medium) with an indication of the baseline image from which they were extracted (e.g., identifier, pointer, address and/or the like) and the label (i.e., significant or non-significant AAA growth) associated with the baseline image. It will be appreciated that during training, features may be retrieved from storage and provided to the ML models instead of being re-extracted from the same baseline images each time.

In one or more alternative implementations, the labelling procedure 370 is configured to generate a separate labelled training dataset for each type of extracted features with their associated labels.

The labelling procedure 350 outputs, for each baseline image associated with a given patient, a respective label, the respective label being one of: non-significant AAA growth and significant AAA growth.

### Calcification Measurement Procedure

The calcification measurement procedure 380 is configured to measure, for each patient, accumulation of calcification in images labelled as showing significant AAA growth and non-significant AAA growth.

The purpose of the calcification measurement procedure 380 is to measure calcification accumulation in each patient to determine a relation between aortic calcification and AAA growth.

In one or more implementations, the calcification measurement procedure 380 uses the segmented calcifications obtained from the segmentation procedure 350 to determine calcification accumulation. In one or more other implementations, the calcification measurement procedure 380 uses a segmentation model of the set of segmentation models 280 to extract calcification from the baseline image.

The calcification measurement procedure 380 calculates the number of pixels of segmented calcifications in each slice for each patient. In some implementations, the calcification measurement procedure 380 may calculate the number of calcification pixels by using a threshold, for example by calculating the third quartile of a number of calcification pixels over all the slices of the baseline stack per patient.

The calcification measurement procedure 380 outputs, for each baseline of each patient, an amount of calcification.

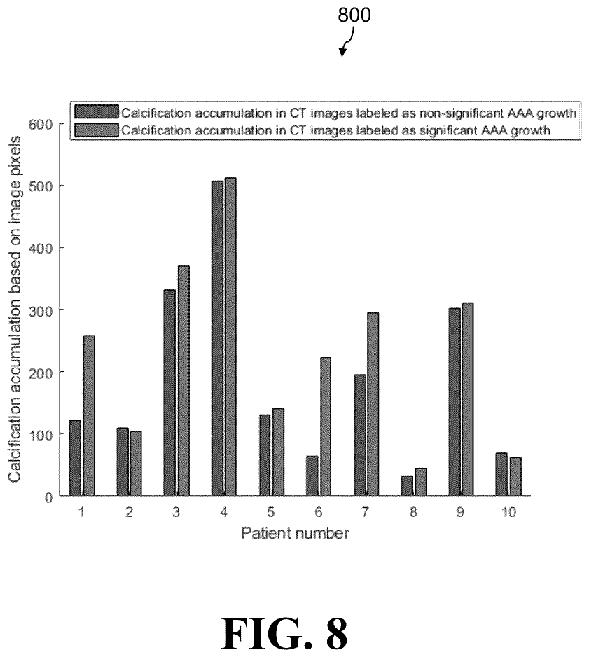

With brief reference to FIG. 8, there is illustrated a chart 800 showing calcification accumulations in pixels (y-axis) as a function of the patient number (x-axis) which compares calcification in slices that were labeled as significant growth (right bar) versus the slices that were labeled as non-significant growth (left bar) for each patient. The results demonstrate the direct relationship between calcification and significant growth. For example, patient number 6 shows maximum AAA growth, and there is a higher amount of calcification in slices that were labeled as showing significant growth (right bar) versus the slices that were labeled as showing non-significant AAA growth (left bar). On the other hand, patient number 2 and patient number 10 are examples of patients showing minimal AAA growth, and the amount of calcification is almost equal in slices showing significant (right bar) and non-significant growth (left bar).

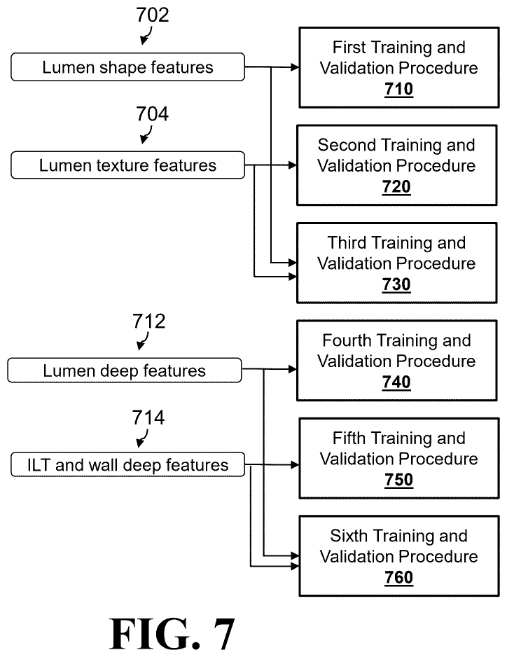

Now referring to FIG. 7 as well as FIG. 4, the training and validation procedure 700 will be described in more detail in accordance with one or more non-limiting implementations of the present technology.

### Training Procedure

The training and validation procedure 700 is executed by the server 230. It will be appreciated that that the training and validation procedure 700 may be executed in a distributed manner by a plurality of computing devices, and some training sub-procedure(s) may be executed in parallel or in sequence.

The purpose of the training and validation procedure 700 is to train models to perform classification of baseline images as showing significant growth or non-significant AAA growth based on the features extracted and output by the feature extraction procedure 500. To achieve that purpose, the classifiers 270 are trained with the labels (i.e., showing significant growth or non-significant growth) output by the labelling procedure 370 as ground truth.

The training and validation procedure 700 retrieves, for each baseline image, the different type of features and the label associated with the respective baseline image. It will be appreciated that the different types features and associated label may be stored in the database 235 or another storage medium.

In one or more implementations, the training and validation procedure 700 executes a separate training of the models based on each of: texture features, shape features and deep features as well as at least some combinations thereof (i.e., texture and shape features; and deep features) so as to determine which features are the best predictors of AAA growth.

In one or more implementations, the training and validation procedure 700 may be executed such that one or more classifiers 270 are trained to consider features of more than one baseline image in the subset of baseline images. It will be appreciated that in such implementations, the one or more classifiers 270 may consider consecutive or non-consecutive images (e.g., consecutive slices in an image stack or non-consecutive slices in an image stack). Additionally, the one or more classifiers 270 may be further configured to consider features parallel to the sagittal plane (i.e., z-axis or vertical growth direction) in addition to feature parallel to the transverse plane (i.e., x-y axis or horizontal growth direction) for a plurality of images in the subset of baseline images.

The training and validation procedure 700 executes a separate training of the classification models 270 for the features extracted only from the lumen, features extracted only from the segmented ILT, and for features extracted from a combination of segmented lumen and segmented ILT.

The training and validation procedure 700 comprises inter alia a first training and validation procedure 710, a second training and validation procedure 720, a third training and validation procedure 730, a fourth training and validation procedure 740, a fifth training and validation procedure 750 and a sixth training and validation procedure 760. It will be appreciated that the procedures 710, 720, 730, 740, 750 and 760 may be executed at different moments in time, may be executed in sequence or in parallel.

In one or more implementations, the training and validation procedure 700 performs initialization of the set of classification models 270. In one or more other implementations, the training and validation procedure 700 receives the set of classification models 270 which already have been initialized and/or pre-trained.

In one or more implementations, the set of classification models 270 are implemented as ensemble tree classifiers.

The training and validation procedure 700 performs training of each of the set of classification models 270.

It will be appreciated that the training and validation procedure 700 uses the same initial model in the set of classification models 270 when performing training and validation procedures 710, 720, 730, 740, 750, 760 such that performance of the models with regard to different types of features may be compared and assessed. The training and validation procedure 700 may then be repeated for different types of models with regard to different types of features such that the type of features (or combination of features) that are best indicative of AAA growth may be determined.

During training, each of the set of classification models 270 performs a classification of each baseline image based on the provided features. A loss function is then used to calculate a loss based on the prediction and the label associated with the baseline image, and parameters of the classification models 270 are updated based on the calculated loss. This procedure is repeated iteratively until convergence and/or reaching a stopping criterion, as known in the art. In one or more implementations, the training and validation procedure 700 may stop upon reaching one or more of: a desired performance threshold (e.g. accuracy for classification tasks with minimal overfitting), a computing budget, a maximum training duration, a lack of improvement in performance, a system failure, and the like.

The training and validation procedure 700 then outputs a set of trained classification models 270, also referred to as trained classifiers 270, where each classifier has been trained on different features.

### Shape Features

The first training and validation procedure 710 trains at least one given classification model 270 to predict AAA growth in images based on lumen shape features 702.

The classification models 270 use the lumen shape features 702 to classify each baseline image as showing significant or non-significant AAA growth.

In one or more implementations, the first training and validation procedure 710 trains the classification models 270 based on HOG features extracted from the lumen at each slice to predict AAA growth. The HOG features are indicative of a lumen shape.

Validation is then performed using a portion of the dataset so as to fine tune model parameters of the given classification model 270.

Upon a termination condition being reached, the first training and validation procedure 710 stops and outputs a given trained classification model 270 having been trained based on lumen shape features 702.

### Texture Features

The second training and validation procedure 720 trains at least one given classification model 270 to classify images based on the lumen texture features 704.

The classification models 270 use the lumen texture features 704 to classify each image as showing significant or non-significant AAA Growth.

In one or more implementations, the second training and validation procedure 720 trains ensemble tree classifier based on GLCM features extracted from lumen at each slice along with the corresponding growth label to predict AAA growth by considering only lumen contrast inhomogeneity.

Validation is then performed using a portion of the dataset so as to fine tune model parameters of the given classification model 270.

Upon a termination condition being reached, the second training and validation procedure 720 stops and outputs a given trained classification model 270 having been trained based on lumen texture features 704.

### Shape and Texture Features

The third training and validation procedure 730 trains at least one given classification model 270 to classify images based on the lumen shape features 702 and the lumen texture features 704.

In one or more implementations, the third training and validation procedure 730 trains the set of classification models 270 to classify images based on a combination of GLCM and HOG features extracted from the lumen at each slice along with the corresponding growth label to predict AAA growth by considering both the lumen shape and the lumen contrast inhomogeneity.

Upon a termination condition being reached, the third training and validation procedure 730 stops and outputs a given classification model 270 having been trained based on the lumen shape features 702 and the lumen texture features 704.

Validation is then performed using a portion of the dataset so as to fine tune model parameters of the given classification model 270.

The third training and validation procedure 730 outputs a given trained classification models 270 having been trained to perform AAA growth prediction based on the lumen shape features 702 and the lumen texture features 704.

### Lumen Deep Features

The fourth training and validation procedure 740 trains the set of classification models 270 to classify images based on the lumen deep features 712 extracted by the trained feature extractor 260.

In one or more implementations, the fourth training and validation procedure 740 trains at least one given classification model 270 to classify images based on the lumen deep features 712 extracted at each baseline slice along with the corresponding growth label to predict AAA growth by considering all the features of the lumen.

Validation is then performed using a portion of the dataset so as to fine tune the model parameters of the given classification model 270.

Upon a termination condition being reached, the fourth training and validation procedure 740 stops and outputs a given trained classification model 270 having been trained based on lumen deep features 712.

### ILT and Wall Deep Features

The fifth training and validation procedure 750 trains at least one given classification model 270 to classify images based on the ILT and wall deep features 714 extracted by the trained feature extractor 260.

In one or more implementations, the fifth training and validation procedure 750 trains at least one classification model 270 to classify images based on the ILT and wall deep features 714 extracted at each slice along with the corresponding growth label to predict AAA growth by considering all the attributes of the ILT and wall.

Validation is then performed using a portion of the dataset so as to fine tune model parameters of the given classification model 270.

Upon a termination condition being reached, the fifth training and validation procedure 750 stops and outputs at least one trained classification model 270 having been trained based on the ILT and wall deep features 714.

### Lumen and ILT and Wall Deep Features

The sixth training and validation procedure 760 trains at least one given classification model 270 to classify images based on the lumen deep features 712 and the ILT and wall deep features 714 extracted by the trained feature extractor 260.

Upon a termination condition being reached, the sixth training and validation procedure 760 stops and outputs at least one trained classification model 270 having been trained based on the lumen deep features 712 and the ILT and wall deep features 714.

Thus, the training and validation procedure 700 outputs a plurality of trained classification models 270, where each trained classification model 270 has been trained on a respective one of: the lumen shape features 702; the lumen texture features 704; the lumen shape features 702 and the lumen texture features 704; the lumen deep features 712; the ILT and wall deep features 714; the lumen deep features 712 and the ILT and wall deep features 714.

It will be appreciated that features from other segmented tissues may be considered and additional classification models 270 may be trained on the features from other segmented tissues not detailed above.

As such, the performance of each trained classification model 270 in predicting AAA growth may be compared and assessed.

### Experimental Results

In one or more implementations, the set of classification models 270 were implemented as ensemble tree classifiers and trained using the RUSBoost method which combines random undersampling and boosting to deal with data with imbalanced class samples.

Training and testing were performed in different steps to evaluate the contribution of each factor in AAA growth prediction. The training dataset included images of 10 patients with 100 slices each (total of 1000 slices). The set of classification models 270 were trained on 80% of the slices and tested on 20% of the remaining slices at each step of the training.

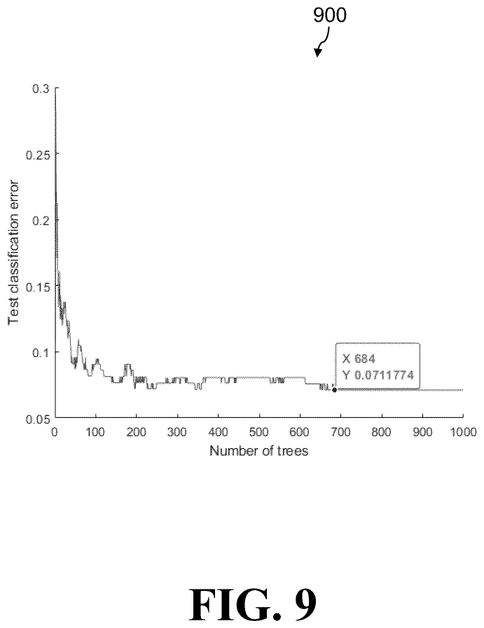

With brief reference to FIG. 9, there is illustrated a plot 900 of the test classification error (y axis) as a function of the number of trees (x-axis). The number of trees was set to 684 by evaluating the performance of the classifier for 1000 trees (FIG. 9), and the learning rate was set to 0.01.

The confusion matrix was calculated at each step to assess the contribution of each of the set of features in growth prediction by evaluating the classifier performance. By defining the positive class as non-significant growth and negative class as significant growth, the confusion matrix was calculated using the following:

| | |
|---|---|
| TP | FN |
| FP | TN |

Where TP represents the CT slices that are correctly classified as non-significant growth, FP determines the CT slices that are incorrectly classified as non-significant growth, TN represents the CT slices that are correctly classified as significant growth, and FN determines the CT slices that are incorrectly classified as significant growth.

Using the confusion matrix, accuracy, sensitivity, and specificity at each step of the work was measured:

TABLE 1
Measured accuracy, sensitivity, specificity at each step

| Tissues under review | Accuracy | Sensitivity | Specificity |
|---|---|---|---|
| Lumen contrast | 0.62 | 0.65 | 0.59 |
| (GLCM features) | | | |
| Lumen shape | 0.84 | 0.96 | 0.72 |
| (HOG features) | | | |
| Lumen shape & | 0.84 | 0.94 | 0.74 |
| contrast (GLCM & | | | |
| HOG features) | | | |
| Lumen (deep | 0.82 | 0.89 | 0.74 |
| features) | | | |
| ILT (deep features) | 0.82 | 0.87 | 0.76 |
| Lumen & ILT | 0.84 | 0.88 | 0.79 |
| (deep features) | | | |

Developers have appreciated that the results demonstrate that lumen and ILT features are powerful features in predicting significant growth. Lumen shape shows more contribution than lumen contrast in growth prediction. The combination of lumen shape and lumen contrast is more powerful in predicting significant growth than lumen shape alone or lumen contrast alone. The feature extractor extracted features approximately 10 times faster than handcrafted features. The results show that automatic features are more descriptive than handcrafted features because of the balance between the predictions.

Thus, it will be appreciated that lumen shape features extracted from baseline images of patients having been diagnosed with AAA provide an indication of AAA growth in patients when classified by a trained classifier in accordance with one or more implementations of the present technology. The lumen shape features may be combined with lumen contrast features to provide an indication of AAA growth when classified by a trained classifier of the present technology. Deep features of lumen and/or ILT output by a feature extractor may also be used to perform the predictions.

Additionally, accumulation of calcification in the baseline images may be calculated to provide a further indication of AAA growth.

### Method Description

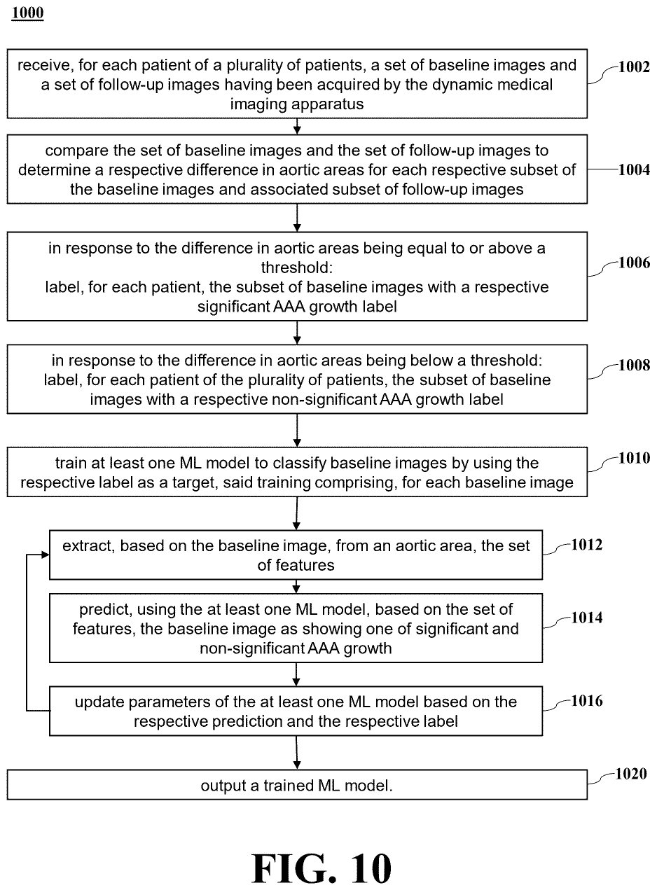

FIG. 10 depicts a flowchart of a method 1000 for training at least one model to predict abdominal aortic aneurysm (AAA) growth in images, the method 1000 being executed in accordance with one or more non-limiting implementations of the present technology.

In one or more alternative implementations of the present technology, the method 1000 may be adapted and used to train models to predict growth of other types of aneurysms in blood vessels, such as thoracic aneurysms.

In one or more implementations, the server 230 comprises at least one processor such as the processor 110 and/or the GPU 111 operatively connected to a non-transitory computer readable storage medium such as the solid-state drive 120 and/or the random-access memory 130 storing computer-readable instructions. The at least one processor, upon executing the computer-readable instructions, is configured to or operable to execute the method 1000.

The method 1000 begins at processing step 1002.

According to processing step 1002, the at least one processor receives, for each patient of a plurality of patients, a set of baseline images and a set of follow-up images image having been acquired by the medical imaging apparatus 210.

In one or more implementations, the set of baseline images comprises a baseline image stack and the set of follow-up images comprises a follow-up image stack acquired by the medical imaging apparatus 210. Each of the baseline and follow-up image stacks may be multiphase stacks.

Each patient has been previously diagnosed with AAA. It will be appreciated that in alternative implementations, the patient may have been diagnosed with another type of aneurysm, such as a thoracic aneurysm.

It will be appreciated that the set of baseline images and the set of follow-up images may be received at different moments in time. The set of baseline images has been acquired during a first or baseline imaging session, and the set of follow-up images has been acquired during a second or follow-up imaging session.

According to processing step 1004, the at least one processor compares, for each patient of the plurality of patients, the set of baseline images and the set of follow-up image to determine a respective difference in aortic areas for a respective subset of the baseline images and associated follow-up images.

In one or more implementations, to perform the comparison, prior to processing step 1004, the processor performs registration of the set of baseline images and the set of follow-up images so as to compare the same imaged anatomical region/slice, e.g., the same aortic area in the baseline image with one follow-up image.

In one or more implementations, for each patient, the at least one processor performs the comparison of the set of baseline images with the set of follow-up images by comparing each subset of baseline images with an associated subset of follow-up images. It will be appreciated that the subset of baseline images may comprise at least one image and the subset of follow-up images may comprise at least one corresponding follow-up image.

In one or more implementations, the comparison of the set of images and the set of baseline images may be performed on an image-by-image basis (i.e., only one image per subset of baseline and follow-up images). In one or more alternative implementations, the comparison of the set of images may be performed for a plurality of images in the subset of baseline and follow-up images and may include comparison of areas parallel to the sagittal plane (in the y or vertical direction) to assess growth in 3D.

In one or more implementations, the processor obtains, for each patient, a set of measurements (e.g., in pixels) of the difference in aortic areas.

According to processing step 1006, in response to the respective difference in aortic areas being above a threshold: the at least one processor labels, for each patient, the respective subset of baseline images with a respective significant AAA growth label.

In one or more implementations, each respective subset of baseline images comprises a single baseline image, and the at least one processor labels each baseline image with the aortic area above a threshold with a respective significant AAA growth label. In one or more other implementations, each respective subset of baseline images comprises a plurality of baseline images, and the processor may label the subset of baseline images with a respective significant AAA growth label.

In one or more implementations, the processor calculates a respective difference in the number of pixels in the aortic areas between corresponding subsets of baseline and follow-up images.

According to processing step 1008, in response to the respective difference in aortic areas being below a threshold, the at least one processor labels, for each patient of the plurality of patients, the respective baseline image with a respective non-significant AAA growth label.

In one or more implementations, each respective subset of baseline images comprise a single baseline image, and the processor labels each baseline image with the aortic area above a threshold with a respective non-significant AAA growth label.

In one or more other implementations, each respective subset of baseline images comprises a plurality of baseline images, and the processor may label the subset of baseline images with a respective non-significant AAA growth label.

In one or more implementations, the at least one processor determines a threshold based on the third quartile (Q₃) of the measured difference of pixels (Ds) over all the slices of all the patients. If the difference is below the third quartile, the processor determines that the patient is showing non-significant AAA growth for the respective subset of baseline and follow-up images. If the difference is equal to or above the third quartile, the comparison procedure 360 determines that the patient is showing significant AAA growth for the respective subset of baseline and follow-up images.

According to processing step 1010, the at least one processor trains at least one ML model to classify baseline images based on features thereof by using the respective label as a target. Processing step 1010 comprises processing steps 1012-1016.

In one or more implementations, the at least one ML model is the set of classifiers 270. In one or more implementations, the set of classifiers 270 may each be implemented as ensemble trees.

In one or more implementations, the set of classifiers 270 may be configured to consider and correlate features between more than one consecutive or non-consecutive baseline image. In such implementations, the set of classifiers 270 may be further configured to consider growth in 3D (e.g., by taking into account the z direction in addition to the x-y directions) for the subset of images comprising a plurality of images.

According to processing step 1012, the processor extracts, for each respective subset of baseline images of each patient, from an aortic area, a respective set of features.

In one or more implementations, the respective set of features comprises shape features of the lumen. The shape features may comprise HOG features.

In one or more other implementations, the respective set of features comprises texture features at least indicative of a contrast of the lumen. The texture features may comprise GLCM features.

In one or more implementations, the processor uses a feature extractor 260 to extract deep features as part of the respective set of features. The deep features may be extracted from a segmented lumen and/or segmented walls and ILT.

According to processing step 1014, the processor classifies, using the at least one ML model, based on the set of features, the respective subset of baseline images as showing one of a significant and non-significant AAA growth to obtain a respective prediction of AAA growth.

According to processing step 1016, the processor updates parameters of the at least one ML model based on the respective prediction and the respective label. In one or more implementations, the at least one ML model is a set of classifiers 270.

A loss function is used to calculate a loss based on the prediction and the respective label associated with the baseline image, and parameters of the classification models 270 are updated based on the calculated loss.

Processing steps 1012-1016 are repeated until a termination condition is reached. The termination condition may include: a desired performance threshold (e.g. accuracy for classification tasks), a computing budget, a maximum training duration, a lack of improvement in performance, a system failure, and the like.

According to processing step 1018, the processor outputs a trained ML model. The processor outputs at least one trained classifier 270.

It will be appreciated that the at least one trained classifier 270 has been trained to classify baseline images of a patient. The at least one trained classifier 270 has learned one or more functions that correlate the features extracted from the aortic areas to presence or absence of AAA growth.

It will be appreciated that while in some implementations the at least one trained classifier 270 is trained according to labels on the subset of baseline images comprising one respective label per baseline image, it should be understood that in other implementations, the at least one trained classifier 270 may learn to consider the subset of baseline images with a plurality of baseline images and/or relation between baseline images in the set of baseline images to determine growth.

In one or more other implementations, the at least one trained classifier 270 may be further configured to consider growth in 3D.

The method 1000 then ends.

It will be appreciated that method 1000 may be executed a plurality of times with a respective classifier for different types of features (including combinations thereof) and the performance of the classifiers may be compared.

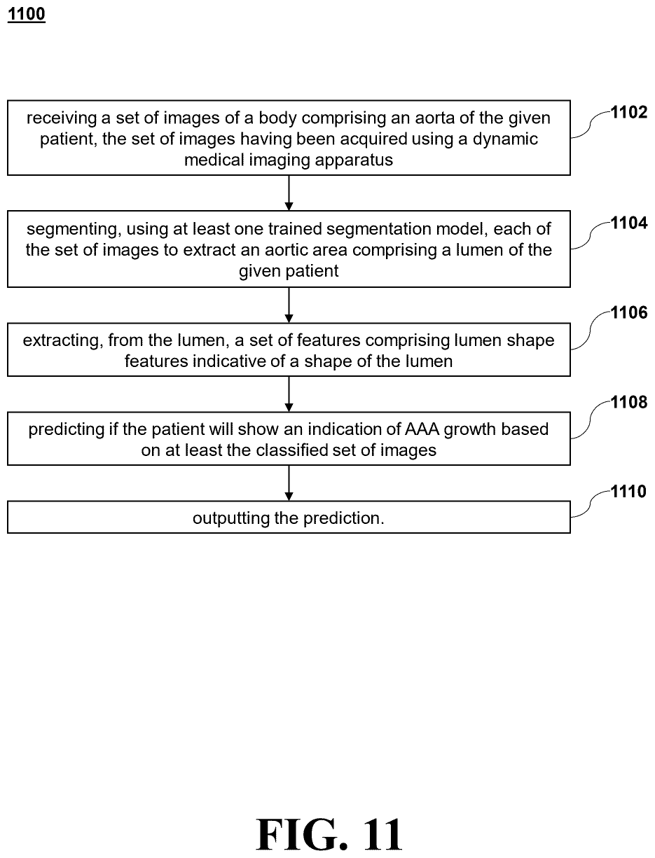

FIG. 11 depicts a flowchart of a method 1100 for using at least one model to predict AAA growth in images of patients having been diagnosed with AAA, the method 1100 being executed in accordance with one or more non-limiting implementations of the present technology.

The method 1100 may be executed after the method 1000, i.e., after training of classifier 270 and having selected a classifier having the classifier having the best performance. In one or more alternative implementations of the present technology, the method 1100 may be adapted and used to train models to predict growth of other types of aneurysms in blood vessels, such as thoracic aneurysms.

In one or more implementations, the server 230 comprises at least one processor such as the processor 110 and/or the GPU 111 operatively connected to a non-transitory computer readable storage medium such as the solid-state drive 120 and/or the random-access memory 130 storing computer-readable instructions. The processor, upon executing the computer-readable instructions, is configured to or operable to execute the method 1100.

The method 1100 begins at processing step 1102.

According to processing step 1102, the at least one processor receives a set of images of a body comprising an aorta of the given patient, the set of images comprising at least one image, the set of images having been acquired using a medical imaging apparatus 210.

In one or more implementations, the set of images is in the form of a stack.

According to processing step 1102, the at least one processor segments, using at least one trained segmentation model 280, each of the set of images to extract an aortic area comprising at least a lumen of the given patient.

According to processing step 1104, the at least one processor extracts, from the lumen, a set of features comprising lumen shape features indicative of a shape of the lumen.

In one or more implementations, the set of features comprises a set of lumen texture features indicative of at least a contrast of the lumen of the given patient, and said classifying is further based on the set of lumen texture features.

In one or more implementations, the set of lumen shape features comprise HOG features.

In one or more implementations, the set of lumen texture features comprise GLCM features.

In one or more implementations, said extracting, from the lumen, the set of features is performed by a feature extraction model 260, the set of features corresponding to deep features.

In one or more implementations, the set of features may comprise ILT and wall features.

According to processing step 1106, the processor classifying, using the trained classifier 270, based on at least the set of features, each of the set of images as being indicative of AAA growth or not being indicative of AAA growth to obtain a set of classified images for the given patient.

According to processing step 1108, the processor predicts if the patient will show AAA growth based on at least the classified set of images.

In one or more implementations, the processor segments using the at least one trained segmentation model, calcifications in the aortic area of each of the set of images, calculates an amount of calcification in each of the set of classified images, and determines if the amount of calcification is above a threshold. In response to the amount of calcification being above the threshold: the processor outputs the amount of calcification as a further indicator of AAA growth for the given patient.

According to processing step 1110, the processor outputs the prediction.

It will be appreciated that the prediction provided by the present method and system is solely an indication of AAA growth based on image features in images of a patient, and may be combined with other methods for assessing AAA growth in patients already diagnosed with AAA. As a non-limiting example, the prediction may be used in combination with other features/types of features to assess growth of AAA.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Modifications and improvements to the above-described implementations of the present technology may become apparent to those skilled in the art. The foregoing description is intended to be exemplary rather than limiting.

1. A method for training at least one classifier to predict abdominal aortic aneurysm (AAA) growth in images acquired by a medical imaging apparatus, the method being executed by at least one processor, the method comprising:
for each patient of a plurality of patients:
receiving a set of baseline images and a set of follow-up images having been acquired by the medical imaging apparatus in a different imaging session, each patient having been diagnosed with AAA;
comparing the set of baseline images and the set of follow-up image to determine a respective difference in aortic areas for each respective subset of the baseline images and associated subset of follow-up images;
in response to the respective difference in aortic areas being above a threshold:
labelling the respective subset of baseline images with a respective significant AAA growth label; and
in response to the respective difference in aortic areas being below a threshold for the respective subset of baseline image and the associated subset of follow-up images:
labelling the respective subset of baseline images with a respective non-significant AAA growth label;
extracting, for the respective subset of baseline images, a respective set of features from the aortic area;
training at least one classifier to classify the set of baseline images based on the respective set of features by using the respective label as a target, said training comprising, for each baseline image;
classifying, using the at least one classifier, based on the set of features, the respective subset of baseline images as showing one of significant and non-significant AAA growth to obtain a respective prediction of AA growth; and
updating at least one parameter of the at least one classifier based on the respective prediction and the respective label; and
outputting a trained classifier comprising updated parameters.

2. The method of claim 1, wherein the respective set of features comprises shape features having been extracted from a lumen in the baseline image.

3. The method of claim 2, wherein the shape features comprise histogram of oriented gradients (HOG) features.

4. The method of any one of claim 1, wherein the respective set of features comprises texture features indicative of contrast having been extracted from a lumen in the baseline image.

5. (canceled)

6. The method of claim 1, wherein said extracting, for the respective baseline image, the respective set of features comprises using at least one feature extractor to extract deep features from the lumen in images acquired by the medical imaging apparatus.

7. The method of claim 6, wherein the at least one feature extractor is configured to extract deep features from a lumen, vessel walls and an intraluminal thrombus (ILT).

8. (canceled)

9. The method of any one of claim 1, wherein the at least one classifier comprises ensemble trees.

10. The method of any one of claim 1, wherein each respective subset of baseline images comprises a plurality of baseline images and each associated subset of follow-up images each comprises an associated plurality of follow-up images.

11. The method of claim 10, wherein the respective difference in aortic areas comprises a respective difference in aortic areas parallel to the transverse plane and parallel to the sagittal plane.

12.-18. (canceled)

19. A system for training at least one classifier to predict abdominal aortic aneurysm (AAA) growth in images acquired by a medical imaging apparatus, the system comprising:
a non-transitory computer-readable medium storing instructions; and
at least one processor operatively connected to the non-transitory computer-readable medium,
the at least one processor, upon executing the instructions, being configured for:
for each patient of a plurality of patients:
receiving a set of baseline images and a set of follow-up images having been acquired by the medical imaging apparatus in a different imaging session, each patient having been diagnosed with AAA;
comparing the set of baseline images and the set of follow-up image to determine a respective difference in aortic areas for each respective subset of the baseline images and associated subset of follow-up images;
in response to the respective difference in aortic areas being above a threshold:
labelling the respective subset of baseline images with a respective significant AAA growth label; and
in response to the respective difference in aortic areas being below a threshold for the respective subset of baseline image and the associated subset of follow-up images:
labelling the respective subset of baseline images with a respective non-significant AAA growth label;
extracting, for the respective subset of baseline images, a respective set of features from the aortic area;
training at least one classifier to classify the set of baseline images based on the respective set of features by using the respective label as a target, said training comprising, for each baseline image;
classifying, using the at least one classifier, based on the set of features, the respective subset of baseline images as showing one of significant and non-significant AAA growth to obtain a respective prediction of AAA growth; and
updating at least one parameter of the at least one classifier based on the respective prediction and the respective label; and
outputting a trained classifier comprising updated parameters.

20. The system of claim 19, wherein the respective set of features comprises shape features having been extracted from a lumen in the baseline image.

21. The system of claim 20, wherein the shape features comprise histogram of oriented gradients (HOG) features.

22. The system of any one of claim 19, wherein the respective set of features comprises texture features indicative of contrast having been extracted from a lumen in the baseline image.

23. The system of claim 22, wherein the texture features comprise gray-level co-occurrence matrix (GLCM) features.

24. The system of claim 19, wherein said extracting, for the respective baseline image, the respective set of features comprises using at least one feature extractor to extract deep features from the lumen in images acquired by the medical imaging apparatus.

25. The system of claim 24, wherein the at least one feature extractor is configured to extract deep features from the lumen, vessel walls and an intraluminal thrombus (ILT).

26. The system of claim 25, wherein the at least feature extractor comprises a convolutional neural network (CNN).

27. The system of any one of claim 19, wherein the at least one classifier comprises ensemble trees.

28. The system of any one of claim 19, wherein each respective subset of baseline images comprises a plurality of baseline images and each associated subset of follow-up images each comprises an associated plurality of follow-up images.

29. The system of claim 28 wherein the respective difference in aortic areas comprises a respective difference in aortic areas parallel to the transverse plane and parallel to the sagittal plane.

30.-40. (canceled)
